(19) United States
(12) Patent Application Publication
(10) Pub. No.: US 2012/0120002 A1
(43) Pub. Date: May 17, 2012

(54) SYSTEM AND METHOD FOR DISPLAY PROXIMITY BASED CONTROL OF A TOUCH SCREEN USER INTERFACE

(75) Inventor: Takaaki Ota, San Diego, CA (US)

(73) Assignee: Sony Corporation, Tokyo (JP)

(21) Appl. No.: 12/948,472

(22) Filed: Nov. 17, 2010

(51) Int. Cl. G06F 3/041

(52) U.S. Cl. 345/173

(57) ABSTRACT

A touch screen user interface features manipulating an object (e.g. a fingertip) near a display, identifying a target point according to the object trajectory and a nonzero display distance, and performing an interface event at the target point computed as a projected intersection point between the object and the display, a hovering point, or by determining when the object crosses a display distance threshold or approaches the display faster than a predetermined speed. The interface event includes triggering a popup menu, moving a cursor, clicking a tool tip, clicking a hotkey, or adjusting a display image, and is activated by hovering the object for a duration, moving the object faster than a velocity threshold, crossing a second display distance threshold, crossing multiple display distance thresholds within a time limit, or by moving multiple objects simultaneously. The interface may properly control Flash®-based applications without separate pointing and selecting mechanisms.

### FIELD OF THE INVENTION

The present patent document relates in general to enhancing the user interface capabilities of a touch screen device and more particularly to enhancing non-contact interaction with a capacitive touch screen user interface to enable performance similar to devices having conventional pointing and selecting mechanisms.

### BACKGROUND OF THE INVENTION

Touch screen devices are becoming more common, being used currently for example in cellular telephones, personal digital assistants (PDAs) and other handheld computing or gaming devices, digital cameras, keyboards, laptop computers, and monitors. Touch screen user interfaces typically combine a display unit capable of depicting visual output with an overlying touch sense unit capable of detecting user input via touch. The commonly used capacitive touch sense unit has a grid or screen of capacitive sensor electrodes that are electrically insulated from direct user contact by a thin layer of glass. Associated circuitry measures the capacitance on each column and row electrode in the screen. A finger or other object contacting the touch sense unit, such as a pen or stylus or other physical item used to denote position or movement, will increase the capacitances on the rows and columns that fall under or near the object. This produces a characteristic “bump” in the capacitive profile of each measured dimension, i.e. the rows and columns.

In this sensing scheme, the capacitance change due to an object will typically be largest on the electrode nearest the center of the object. Capacitive change signals are normally detected from multiple individual electrodes, and various algorithms determine the object's precise location by triangulating the signals from the multiple sensing points. Conventional capacitive touch screens can thus calculate the location of an object on the touch screen to a resolution much finer than the physical spacing of the electrodes. One such method, called “peak interpolation,” applies a mathematical formula to a maximal capacitance value and its neighboring values in a dimensional profile to estimate the precise center of the capacitive “bump” due to an object. See for example paragraphs [0018]-[0020] of U.S. Patent Application Publication 2009/0174675A1 by Gillespie et al., which is hereby incorporated herein by reference in its entirety.

Although a strong signal is detected by a capacitive touch screen device when a fingertip actually touches the glass surface, there is a weaker capacitance change even when the fingertip is not directly touching the glass surface but is instead hovering nearby. Normally, the almost-touching signal is rejected as noise, and an actual “touch” is detected only when the signal level exceeds a predetermined threshold value in order to reject false positive “touch” signals. See for example paragraph [0025] of Gillespie et al. previously cited.

While touch screen devices are becoming more popular, they still lack some of the functionality of more conventional input devices that are capable of entirely separate pointing and selecting (e.g. touching or clicking a mouse button) operations. For example, a user interface with a mouse can cause a cursor or tool tip to merely “roll over” an area and trigger a rollover popup menu without requiring a user to click on the mouse button. For capacitive touch screen interfaces, no entirely equivalent technique currently exists. As a result, for example, Apple, Inc. has recently acknowledged that Flash®-based web sites don't always work properly with touch screen devices like the iPhone® that do not have a separate trackball or mouse-like cursor control device. (iPhone is a registered trademark of Apple Inc., registered in the U.S. and other countries, and Flash is a registered trademark of Adobe Systems Incorporated, registered in the U.S. and other countries.) This puts the iPhone® at a disadvantage against other hand-held devices, or even against conventional personal computers. U.S. Patent Application Publication 2010/0020043A1 by Park et al., which is hereby incorporated by reference in its entirety, notes some useful progress toward solving this dilemma, but touch screen device performance is still comparatively limited.

### SUMMARY OF THE EMBODIMENTS

A system, method, and computer program product for interacting with a display is disclosed and claimed herein. In one embodiment, a method for display interaction comprises a user manipulating at least one object in a trajectory in detectable proximity to a display, then identifying a target point according to the trajectory and a nonzero distance from the display, and responsively performing an interface event at the target point according to the trajectory. The display may be a capacitive touch screen display, as used for example in a cellular phone, a personal digital assistant (PDA) or other handheld computing or gaming device, a digital camera, a laptop, a monitor, or a keyboard. The object may be a fingertip, a stylus, or a pen for example.

The target point may be computed as a projected intersection point between the object and the display, or a hovering point. The trajectory includes a display approach rate in a direction normal to the display. The position of the object is determined by interpolative triangulation. The target point may be identified by determining when the object crosses at least one predetermined display distance threshold, which may be calibrated for individual displays and individual objects. The target point can also be identified by determining when a display approach speed exceeds a predetermined display approach speed threshold.

The interface event may include triggering a popup menu, moving a cursor, clicking a tool tip, clicking a hotkey, panning a display image, scrolling the display image, rotating the display image, and zooming the display image. The interface event activation may be controlled by hovering the object over the target point for at least a predetermined duration, moving the object at a velocity exceeding a predetermined velocity threshold, crossing a predetermined second display distance threshold, crossing multiple display distance thresholds within a predetermined time limit, and by moving multiple objects simultaneously. Interacting with the display may enable control of Flash®-based applications.

In another embodiment, a computer program product enables interaction with a display without requiring additional hardware by enabling a user to manipulate at least one object in a trajectory in detectable proximity to a display, identifying a target point according to the trajectory and a nonzero distance from the display, and then responsively performing an interface event at the target point. The display may be a capacitive touch screen display, as used in a cellular phone, a personal digital assistant (PDA) or other handheld computing or gaming device, a digital camera, a laptop, a monitor, or a keyboard. The object may be a fingertip, a stylus, or a pen.

The target point may be computed as a projected intersection point between the object and the display, or a hovering point. The trajectory may include a display approach rate in a direction normal to the display. The position of the object can be determined by interpolative triangulation. The target point may be identified by determining when the object crosses at least one predetermined display distance threshold, which can be calibrated for individual displays and individual objects. The target point may also be identified by determining when a display approach speed exceeds a predetermined display approach speed threshold.

The interface event may include triggering a popup menu, moving a cursor, clicking a tool tip, clicking a hotkey, palming a display image, scrolling the display image, rotating the display image, and zooming the display image. The interface event activation may be controlled by hovering the object over the target point for at least a predetermined duration, moving the object at a velocity exceeding a predetermined velocity threshold, crossing a predetermined second display distance threshold, crossing multiple display distance thresholds within a predetermined time limit, and by moving multiple objects simultaneously. Flash®-based applications can be controlled by interacting with the display.

In yet another embodiment, a system for interacting with a display comprises a user manipulating an object in a trajectory in detectable proximity to a display, a target point that is identified according to the trajectory and a nonzero distance from the display, and finally an interface that is responsively performed at the target point. The display may be a capacitive touch screen display as used in a cellular phone, a personal digital assistant (PDA) or other handheld computing or gaming device, a digital camera, a laptop, a monitor, or a keyboard. The object is typically a fingertip, a stylus, or a pen.

The target point may be computed as a projected intersection point between the object and the display, or a hovering point. The trajectory may include a display approach rate in a direction normal to the display. The position of the object can be determined by interpolative triangulation. The target point may be identified by determining when the object crosses at least one predetermined display distance threshold, which may be calibrated for individual displays and individual objects. The target point can also be identified by determining when a display approach speed exceeds a predetermined display approach speed threshold.

The interface event may include triggering a popup menu, moving a cursor, clicking a tool tip, clicking a hotkey, panning a display image, scrolling the display image, rotating the display image, and zooming the display image. The interface event activation may be controlled by hovering the object over the target point for at least a predetermined duration, moving the object at a velocity exceeding a predetermined velocity threshold, crossing a predetermined second display distance threshold, crossing multiple display distance thresholds within a predetermined time limit, and by moving multiple objects simultaneously. The system allows interaction with the display to enable control of Flash®-based applications.

As described more fully below, the apparatus and processes of the embodiments disclosed permit the improved user interaction with a touch screen display. Further aspects, objects, desirable features, and advantages of the apparatus and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed invention.

### BRIEF DESCRIPTION OF THE DRAWINGS

FIG. 1 depicts a conventional touch screen capacitance versus surface location measurement for a hovering fingertip;

FIG. 2 depicts a conventional touch screen capacitance versus surface location measurement for a touching fingertip;

FIG. 3 depicts a diagram of a display according to an embodiment of the invention; and

FIG. 4 depicts a flow diagram of a process for implementing an embodiment of the invention.

### DETAILED DESCRIPTION OF EXEMPLARY EMBODIMENTS

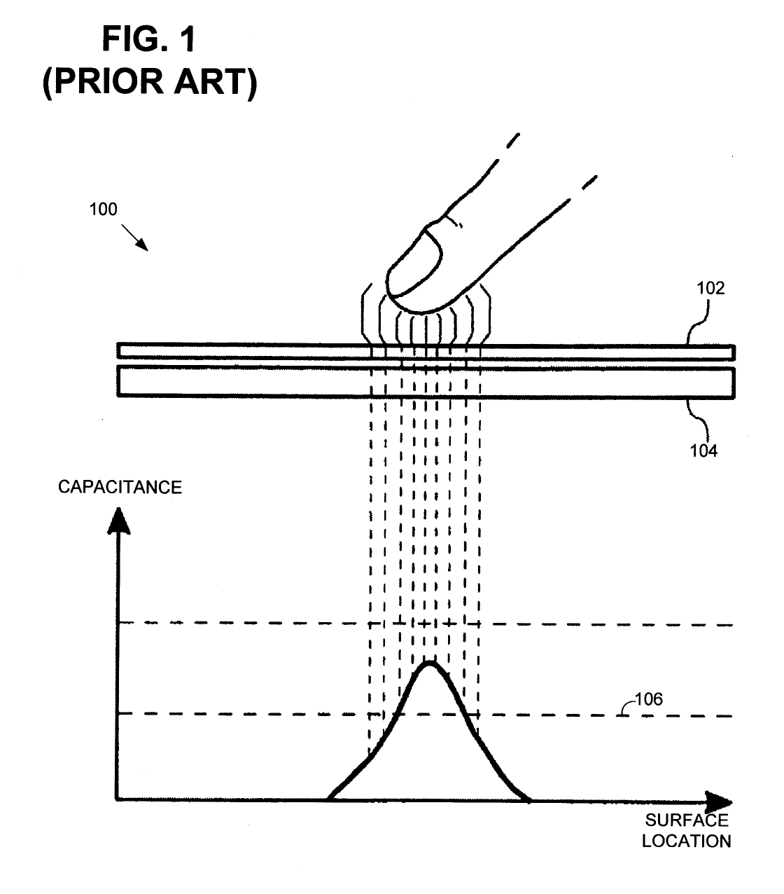

Referring now to the drawings, FIG. 1 shows a conventional technique of touch screen capacitance versus surface location measurement for a hovering fingertip. The touch screen device 100 shown includes a touch sensor 102 over a display unit 104. A first preset critical capacitance value 106 is shown, such that measured capacitances of less than this level are discarded as insignificant.

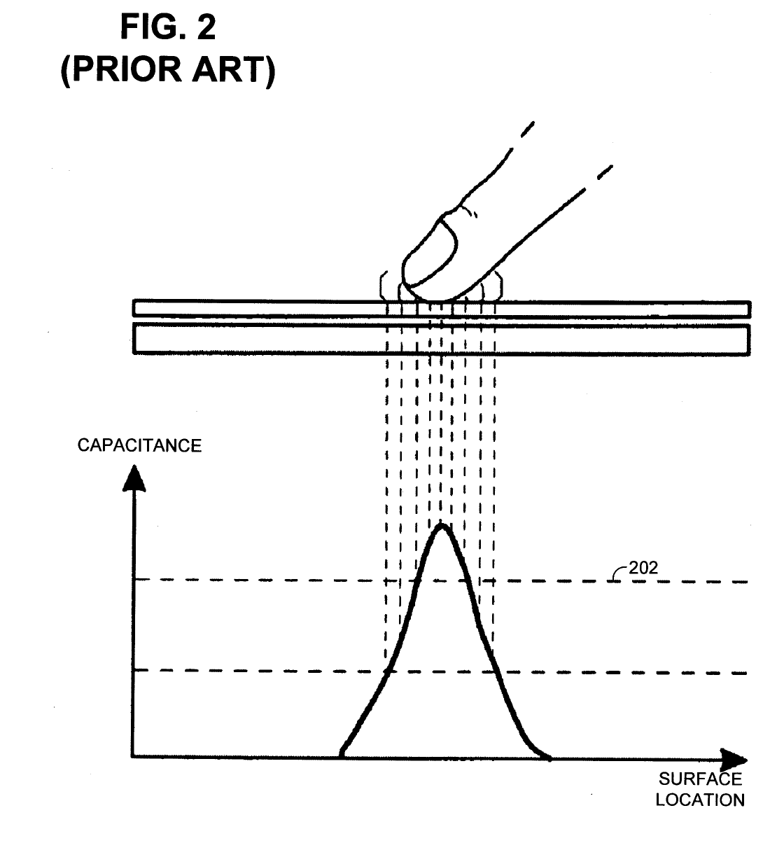

Referring now to FIG. 2, another conventional technique of touch screen capacitance versus surface location measurement is shown, this time for an actual contacting fingertip. A second preset critical capacitance value 202 is shown, such that measured capacitances over this level are indicative of an actual touch being made on the touch screen device. Capacitance values between the first critical value and the second critical value cause the display of a cursor in an area where the change of capacitance is sensed.

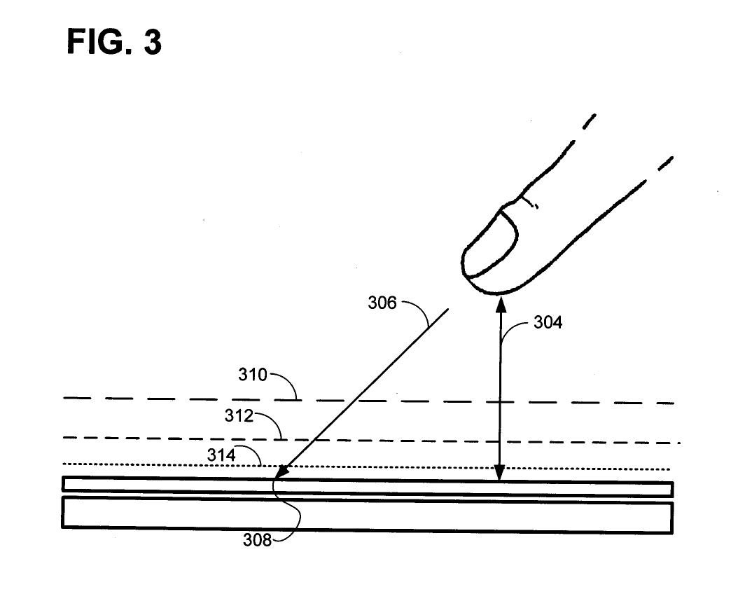

Referring now to FIG. 3, a diagram representing one embodiment of the present invention, a display is shown. This figure notes that an object 302 (a fingertip in this instance) is manipulated by a user in detectable proximity to the display. The display may be a conventional capacitive touch screen display as used in a cellular telephone, a PDA or other handheld computing or gaming device, a digital camera, a laptop, a monitor, or keyboard. The object can traverse a trajectory that traces out various positions at different times over the display, typically at different nonzero normal distances 304 from the touch screen surface. The object may hover over a given point, i.e. have zero speed in any direction for a particular time span. The object may also move in various directions at various speeds, including approaching the display normal to the touch screen surface at an approach rate (e.g. a component of the object's velocity vector 306 will be directly toward or away from the screen). The object's velocity vector (including its various directional components) is thus considered to be part of its trajectory.

While conventional touch screens require a user to touch an object to the screen's glass surface for pointing functionality, embodiments of the present invention do not rely on actual object contact. Instead, a target point 308 is identified according to the object's trajectory and distance from the display. Embodiments of the invention repeat measurements of the object's position (including distance directly above the display) to determine the object's velocity vector. Geometric extension of the object's trajectory predicts a probable contact point at the touch screen's glass surface; this probable contact point is deemed the target point 308, i.e. it corresponds to the point a user would similarly identify with a conventional cursor control device. Incorporation of the motion of the object either toward or away from the display allows the target point to be more precisely computed.

Embodiments of the invention can also identify a target point by determining when the object crosses at least one predetermined display distance threshold 310. In contrast to the prior art, the threshold value is dynamically adjusted so that strict pre-set calibration of the touch screen interface is not necessary. Embodiments of the present invention use a dynamic threshold as follows: when the capacitance is lowest (e.g. noise) and when the capacitance is highest (e.g. an actual fingertip touch), the lower and upper bound values are obtained, then at least one so-called hover value is assigned between these lower and upper bound values. The hover value is not necessarily the same for every single touch screen device, but may vary between individual devices due to manufacturing variations. The hover value may also vary with different fingertips for one or more users. Further, a stylus or pen may cause a different hover value, depending on its material composition, length, point sharpness, etc. A second and subsequent dynamic threshold values 312 and 314, indicating a closer non-touching approach, may also be introduced to more precisely detect proximity of the object before it is actually touching the surface.

Embodiments of the invention may also use the approach speed of a user's fingertip or other object toward the glass surface to help identify the target point. If an approach speed exceeds a predetermined approach speed, for example, embodiments of the invention may determine that the user has already navigated toward a desired location and is moving the object in to make contact with the screen.

Once a target point has been identified, embodiments of the invention perform an interface event at the target point. The interface events include all the functions that may be performed with a convention trackball or mouse type interface, where pointing and clicking/touching are distinct operations. Specifically, the events include triggering a popup menu, moving a cursor, clicking a tool tip, clicking a hotkey, panning a display image, scrolling a display image, rotating a display image, and zooming a display image.

Embodiments of the invention may also choose and trigger the user interface events according to the object trajectory and approach speed, even without actual touch screen contact. Specific trajectories and speeds may enable an embodiment to choose a particular event according to predetermined trajectory interpretations. For example, hovering the object over a particular display location for at least a predetermined duration may trigger a rollover popup menu versus another interface event. Alternately, moving the object rapidly from display top to display bottom at a relatively constant distance from the display may induce scrolling of the display image in the direction of object motion. Similar motion in other lateral directions may trigger panning in the direction of object motion. Moving the object at a velocity greater than a predetermined velocity threshold may be interpreted by embodiments of the invention as a “dismissal” motion, that could for example close a popup menu. A crossing of the second predetermined display distance may trigger for example a submenu highlighting event. An object crossing multiple display distance thresholds within a predetermined time limit (e.g. rapidly “punching through” the thresholds, or alternately moving down, then up, then down again) may be deemed to correspond to an intended mouse click.

Further, embodiments of the invention may also track multiple objects simultaneously, including the distance between each object, and rotation of the object group over the touch screen surface, and responsively select and control user interface events. Display adjustments such as commands to pan, zoom, scroll, and rotate the display image may be more intuitive to a user when based on the coordinated motion of multiple objects. For example, multiple objects maintaining a relatively constant distance but rotating over the touch screen surface may correspond to a command to rotate the display image. Multiple fingertips moving closer together may correspond to a zoom in command, while multiple fingertips moving apart may correspond to a zoom out command. Alternately, the zoom operation may be relatively continuous and based on the display distance or approach speed, or may proceed by discrete stages corresponding to multiple distance thresholds being crossed.

Embodiments of the invention require no new hardware, e.g. a trackball or mouse-like device, to be added to a touch screen device to function. Many hand-held computing devices have a trackball-type cursor control device while the iPhone® product doesn't, but if for example the iPhone® product used an embodiment of the invention then similar functionality would be provided. Thus, Flash®-based applications and other applications designed for use by devices having conventional cursor controls may be controlled properly by embodiments of the invention.

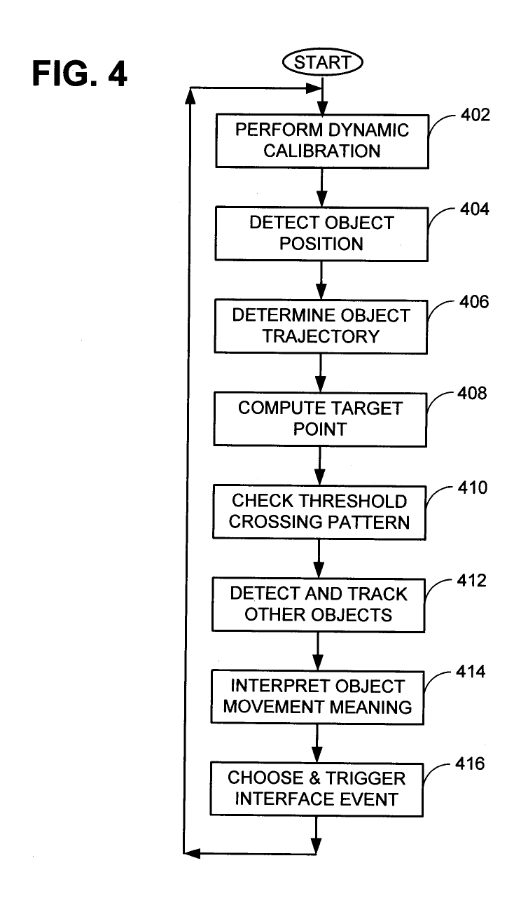

Referring now to FIG. 4, a flow diagram of a process for implementing an embodiment of the invention is shown. First, in step 402 the embodiment determines if an individual object and/or display requires dynamic calibration, which may entail checking a memory to see if values have been stored or recently stored, or following a user's command to perform dynamic calibration. If dynamic calibration is required, it is performed as previously described.

Next, the embodiment proceeds with object tracking. This includes detecting a single object's position (including a display distance) in step 404 via the position triangulation method previously described. The embodiment then repeats the position detection in step 406 to compute a full trajectory for the object detected (including a velocity vector, partially comprising an approach speed). Next, a target point is computed in step 408 based on the object's position and trajectory. The embodiment checks for distance threshold crossings in step 410, including particular patterns of crossings that may have predetermined meanings. In step 412, the object tracking process described above is repeated for any other objects present; depending on the speed of the embodiment, this step may be performed in parallel versus sequentially.

The embodiment then in step 414 interprets the information gleaned during the object tracking phase and determines whether and where a particular interface event should occur. The interface event is then performed by the user interface in step 416 as it would have been if the user had been employing a non-touch-screen input mechanism. The embodiment then repeats its entire operation while the display is active.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, embodiments of the invention are described with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium or computer readable medium, which may include any medium that can store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, a radio frequency (RF) link, etc.

While the invention has been described in connection with specific examples and various embodiments, it should be readily understood by those skilled in the art that many modifications and adaptations of the enhanced display interactions described herein are possible without departure from the spirit and scope of the invention as claimed hereinafter. Thus, it is to be clearly understood that this application is made only by way of example and not as a limitation on the scope of the invention claimed below. For example, although this disclosure describes embodiments of the invention employing capacitive touch screen devices, it will be readily apparent to one of ordinary skill in the art that the embodiments may be operable with other methods of determining object location, such as infrared or ultrasound based methods, etc. The description is thus intended to cover any variations, uses or adaptation of the invention following, in general, the principles of the invention, and including such departures from the present disclosure as come within the known and customary practice within the art to which the invention pertains.

What is claimed is:

1. A method of interacting with a display, comprising:
manipulating at least one object in at least one trajectory in detectable proximity to a display;
identifying a target point according to the trajectory and a nonzero distance from the display; and
responsively performing an interface event at the target point.

2. The method of claim 1 wherein the display is a capacitive touch screen display.

3. The method of claim 1 wherein the display comprises at least one of a cellular phone, a PDA, a handheld computing device, a handheld gaming device, a digital camera, a laptop, a monitor, and a keyboard.

4. The method of claim 1 wherein the object is at least one of a fingertip, a stylus, and a pen.

5. The method of claim 1 wherein the identifying further comprises computing the target point as at least one of a projected intersection point between the object and the display, and a hovering point.

6. The method of claim 1 wherein the trajectory includes a display approach rate in a direction normal to the display.

7. The method of claim 1 wherein the identifying further comprises interpolative triangulation of a position of the object.

8. The method of claim 1 wherein the identifying further comprises determining when the object crosses at least one predetermined display distance threshold.

9. The method of claim 8 wherein the display distance threshold is calibrated for at least one of individual displays and individual objects.

10. The method of claim 1 wherein the identifying further comprises determining when a display approach speed exceeds a predetermined display approach speed threshold.

11. The method of claim 1 wherein the interface event includes at least one of triggering a popup menu, moving a cursor, clicking a tool tip, clicking a hotkey, panning a display image, scrolling the display image, rotating the display image, and zooming the display image.

12. The method of claim 1 wherein the performing is controlled by at least one of hovering the object over the target point for at least a predetermined duration, moving the object at a velocity exceeding a predetermined velocity threshold, crossing a predetermined second display distance threshold, crossing multiple display distance thresholds within a predetermined time limit, and moving multiple objects simultaneously.

13. The method of claim 1 wherein interacting with the display properly operates applications designed for use with devices having conventional cursor controls.

14. A computer program product comprising a computer readable medium tangibly embodying computer readable code means thereon to cause a computing device to enable user interaction with a display by:
manipulating at least one object in at least one trajectory in detectable proximity to a display;
identifying a target point according to the trajectory and a nonzero distance from the display; and
responsively performing an interface event at the target point.

15. The computer program product of claim 14 wherein the display is a capacitive touch screen display.

16. The computer program product of claim 14 wherein the display comprises at least one of a cellular phone, a PDA, a handheld computing device, a handheld gaming device, a digital camera, a laptop, a monitor, and a keyboard.

17. The computer program product of claim 14 wherein the object is at least one of a fingertip, a stylus, and a pen.

18. The computer program product of claim 14 wherein the identifying further comprises computing the target point as at least one of a projected intersection point between the object and the display, and a hovering point.

19. The computer program product of claim 14 wherein the trajectory includes a display approach rate in a direction normal to the display.

20. The computer program product of claim 14 wherein the identifying further comprises interpolative triangulation of a position of the object.

21. The computer program product of claim 14 wherein the identifying further comprises determining when the object crosses at least one predetermined display distance threshold.

22. The computer program product of claim 21 wherein the display distance threshold is calibrated for at least one of individual displays and individual objects.

23. The computer program product of claim 14 wherein the identifying further comprises determining when a display approach speed exceeds a predetermined display approach speed threshold.

24. The computer program product of claim 14 wherein the interface event includes at least one of triggering a popup menu, moving a cursor, clicking a tool tip, clicking a hotkey, panning a display image, scrolling the display image, rotating the display image, and zooming the display image.

25. The computer program product of claim 14 wherein the performing is controlled by at least one of
hovering the object over the target point for at least a predetermined duration,
moving the object at a velocity exceeding a predetermined velocity threshold,
crossing a predetermined second display distance threshold,
crossing multiple display distance thresholds within a predetermined time limit, and
moving multiple objects simultaneously.

26. The computer program product of claim 14 wherein interacting with the display properly operates applications designed for use with devices having conventional cursor controls.

27. A system for interacting with a display, comprising:
at least one object manipulated by a user, the object in at least one trajectory in detectable proximity to a display;
a target point identified according to the trajectory and a nonzero distance from the display; and
an interface event responsively performed at the target point.

28. The system of claim 27 wherein the display is a capacitive touch screen display.

29. The system of claim 27 wherein the display comprises at least one of a cellular phone, a PDA, a handheld computing device, a handheld gaming device, a digital camera, a laptop, a monitor, and a keyboard.

30. The system of claim 27 wherein the object is at least one of a fingertip, a stylus, and a pen.

31. The system of claim 27 wherein identifying the target point further comprises computing the target point as at least one of a projected intersection point between the object and the display, and a hovering point.

32. The system of claim 27 wherein the trajectory includes a display approach rate in a direction normal to the display.

33. The system of claim 27 wherein identifying the target point further comprises interpolative triangulation of a position of the object.

34. The system of claim 27 wherein identifying the target point further comprises determining when the object crosses at least one predetermined display distance threshold.

35. The system of claim 34 wherein the display distance threshold is calibrated for at least one of individual displays and individual objects.

36. The system of claim 27 wherein identifying the target point further comprises determining when a display approach speed exceeds a predetermined display approach speed threshold.

37. The system of claim 27 wherein the interface event includes at least one of triggering a popup menu, moving a cursor, clicking a tool tip, clicking a hotkey, panning a display image, scrolling the display image, rotating the display image, and zooming the display image.

38. The system of claim 27 wherein the interface event is controlled by at least one of hovering the object over the target point for at least a predetermined duration, moving the object at a velocity exceeding a predetermined velocity threshold, crossing a predetermined second display distance threshold, crossing multiple display distance thresholds within a predetermined time limit, and moving multiple objects simultaneously.

39. The system of claim 27 wherein interacting with the display properly operates applications designed for use with devices having conventional cursor controls.
